(19) United States
(12) Patent Application Publication
(10) Pub. No.: US 2026/0071345 A1
(43) Pub. Date: Mar. 12, 2026

(54) PLATED MEMBER AND MANUFACTURING METHOD THEREOF

(71) Applicant: Hitachi Astemo, Ltd., Ibaraki (JP)

(72) Inventors: Akihito HOSHINO, Hitachinaka-shi (JP); Yasuhisa OMATA, Hitachinaka-shi (JP); Hiroshi NAKANO, Hitachinaka-shi (JP)

(21) Appl. No.: 19/108,758

(22) PCT Filed: Sep. 6, 2023
(86) PCT No.: PCT/JP2023/032511

§ 371 Date: Mar. 5, 2025

(30) Foreign Application Priority Data
Sep. 7, 2022 (JP) 2022-142218

(51) Int. Cl. C25D 3/06; F16F 9/32

(52) U.S. Cl. CPC C25D 3/06; F16F 9/3221; F16F 2226/02

(57) ABSTRACT

The present plated member includes, on an outer surface, a plated film mainly composed of chromium deposited from a trivalent chromium bath containing at least chromium, carbon, and oxygen, in which the plated film contains 60 to 80 at % of chromium and 16.5 to 30 at % of carbon and has an indentation hardness of 7 GPa or more on the outer surface, and a degree of crystallinity calculated from a peak integrated intensity ratio of a measured value of X-ray diffraction measurement and the following expression (1) is 4% or less.

### TECHNICAL FIELD

The present invention relates to a plated member and a manufacturing method thereof.

Priority is claimed on Japanese Patent Application No. 2022-142218 filed on Sep. 7, 2022, the contents of which are incorporated herein by reference.

### BACKGROUND ART

A technology in which a chrome-plated layer deposited from a trivalent chromium bath, which poses no problems in terms of toxicity and pollution compared to hexavalent chromium, is used for a platemaking roll is described in the below Patent Document 1.

### CITATION LIST

### Patent Document

Patent Document 1: Japanese Unexamined Patent Application, First Publication No. 2008-143169

### SUMMARY OF INVENTION

### Technical Problem

In a chromium-plated film formed on a rod that is in sliding contact with a sliding component, a plated film deposited from a trivalent chromium bath is considered a promising alternative to a plated film deposited from a hexavalent chromium bath.

Incidentally, through research conducted by inventors of the present invention, it was found that, when a rod on which a plated film deposited from a conventional trivalent chrome bath had been formed was polished, brittle fracture (tearing fracture) of the plated film was generated.

A problem to be solved by the present invention is to provide a plated member such as a rod having a plated film deposited from a trivalent chromium bath and less susceptible to occurrence of tearing fractures during polishing, and a manufacturing method thereof.

### Solution to Problem

A plated member of the present invention includes, on an outer surface, a plated film mainly composed of chromium deposited from a trivalent chromium bath containing at least chromium, carbon, and oxygen, in which the plated film contains 60 to 80 at % of chromium and 16.5 to 30 at % of carbon and has an indentation hardness of 7 GPa or more on the outer surface, and a degree of crystallinity calculated from a peak integrated intensity ratio of a measured value of X-ray diffraction measurement and the following expression (1) is 4% or less.

$$Degree of crystallinity ( peak integrated intensity ratio ) = \{ \text{} ( Crystalline ) / ( Crystalline + Amorphous ) \} \times 100 \% \qquad Expression ( 1 )$$

Here, the indentation hardness indicates a value obtained by instrumented indentation hardness measurement using a nanoindentation method (ISO 14577), and the integrated intensity ratio in expression (1) indicates a value determined in an X-ray diffraction (XRD) analysis under conditions of 20:30° to 60°, a half width of crystalline: <3, and a half width of amorphous: ≥3.

### Advantageous Effects of Invention

According to the present invention, it is possible to provide a plated member having a chromium-plated film which is a plated film mainly composed of chromium deposited from a trivalent chromium bath that poses no environmental problems compared to hexavalent chromium and is less susceptible to occurrence of tearing fractures during polishing. Also, it is possible to provide a technology for manufacturing the plated member.

### BRIEF DESCRIPTION OF DRAWINGS

FIG. 1 A cross-sectional view showing an overall configuration of a shock absorber including a piston rod as a first embodiment of a plated member according to the present invention.

FIG. 2 A front view showing an approximate shape of the piston rod.

FIG. 3 A view showing an upper structure of the shock absorber, and is an enlarged partial cross-sectional view of a part A in FIG. 1.

FIG. 4 A view showing a structure of a distal end part of the piston rod, and is an enlarged partial cross-sectional view of a part B in FIG. 1.

FIG. 5 A flowchart showing an example of a manufacturing process of the piston rod.

FIG. 6 A perspective view of a main part showing an example of a polishing device used for outer diameter polishing of the piston rod.

FIG. 7 A graph showing a relationship between a deposition rate and a degree of crystallinity of plated films formed in examples.

FIG. 8A A graph showing a relationship between a deposition rate and a carbon concentration of the plated films formed in the examples.

FIG. 8B A graph showing a relationship between a deposition rate and an oxygen concentration of the plated films formed in the examples.

FIG. 8C A graph showing a relationship between a deposition rate and a chromium concentration of the plated films formed in the examples.

FIG. 9 A table showing physical property values of the plated films formed in the examples.

FIG. 10 Images showing abrasive marks in brittle mode formed on a plated film of a comparative example sample, in which (A) is an enlarged image at a magnification of 500 times, and (B) is an enlarged image at a magnification of 5000 times.

FIG. 11 Images showing abrasive marks in ductile mode formed on a plated film of an example sample, in which (A) is an enlarged image at a magnification of 500 times, and (B) is an enlarged image at a magnification of 5000 times.

FIG. 12 A graph showing a relationship between a plating hardness and the number of abrasive marks with a width of 8 μm or more in the example samples and comparative example samples.

FIG. 13 A graph showing a relationship between a film carbon content and the number of abrasive marks with a width of 8 μm or more in the example samples and comparative example samples.

FIG. 14 is a graph showing a relationship between a plating hardness and a film carbon content in the example samples and comparative sample samples.

FIG. 15 (A) shows X-ray diffraction analysis results of a comparative example sample, and (B) shows a surface image showing abrasive marks on the same sample.

FIG. 16 (A) shows X-ray diffraction analysis results of an example sample, and (B) shows a surface image showing abrasive marks on the same sample.

FIG. 17 A graph showing a relationship between a deposition rate (film formation rate) and a size of oriented chromium crystal grains of the plated films formed in the examples.

FIG. 18 A TEM image of a cross section of a ductile-mode film for example 2 using a bath type A1.

FIG. 19 (A) shows a TEM image of a cross section of a brittle-mode film for comparative example 1 using the bath type A1, and (B) shows a TEM image of a cross section of a brittle-mode film for comparative example 4 using the bath type A1.

FIG. 20 A TEM image of a cross section of a ductile-mode film for example 5 using a bath type A2.

FIG. 21 (A) shows a TEM image of a cross section of a brittle-mode film for comparative example 9 using the bath type A2, and (B) shows a TEM image of a cross section of a brittle-mode film for comparative example 12 using the bath type A2.

FIG. 22 A view showing an electron diffraction pattern of a cross section of a ductile-mode film for example 2 using the bath type A1.

FIG. 23 (A) shows a view showing an electron diffraction pattern of a cross section of a brittle-mode film for comparative example 1 using the bath type A1, and (B) shows a view showing an electron diffraction pattern of a cross section of a brittle-mode film for comparative example 4 using the bath type A1.

FIG. 24 A view showing an electron diffraction pattern of a cross section of a ductile-mode film for example 5 using the bath type A2.

FIG. 25 (A) shows a view showing an electron diffraction pattern of a cross section of a brittle-mode film for comparative example 9 using the bath type A2, and (B) shows a view showing an electron diffraction pattern of a cross section of a brittle-mode film for comparative example 12 using the bath type A2.

### DESCRIPTION OF EMBODIMENTS

Hereinafter, a shock absorber (cylinder device) having a piston rod as one embodiment of a plated member according to the present invention will be described. Further, the embodiment described below are specifically described to allow a better understanding of the spirit of the invention, and is not intended to limit the present invention unless otherwise specified. Also, scales of the drawings used in the description of the embodiment below have been appropriately changed to make each portion easier to see.

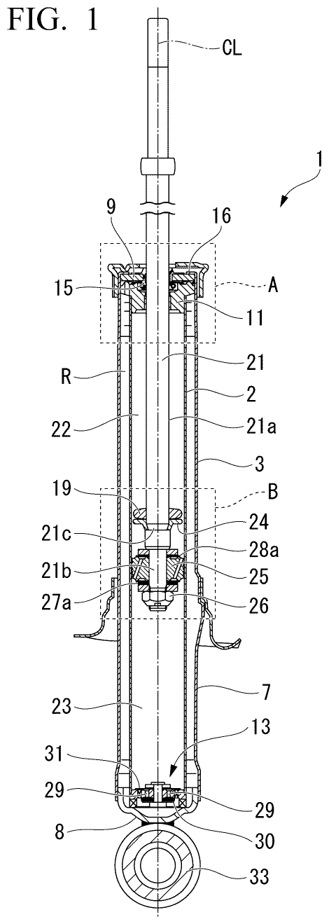

FIG. 1 is a partial cross-sectional view showing an overall structure of a shock absorber (cylinder device) 1 including a piston rod 21 as an example of the plated member according to the present invention.

Although a plated film to be described later is formed on an outer circumferential surface of the piston rod 21, before describing the plated film, an overall configuration of the shock absorber 1 will be described.

### “Cylinder Device”

The cylinder device 1 shown in FIG. 1 is a shock absorber used in a suspension device for an automobile or a railway vehicle, and specifically, is used for a strut-type suspension device for an automobile. The cylinder device 1 includes a cylindrical inner cylinder (cylinder) 2 in which a working fluid is sealed, and a bottomed cylindrical outer cylinder 3 having a larger diameter than the inner cylinder 2, provided on an outer circumferential side of the inner cylinder 2, forming a reservoir chamber R between itself and the inner cylinder 2 in which a working liquid and a working gas are sealed. The cylinder device 1 is a dual-tube type shock absorber in which the inner cylinder 2 is provided inside the outer cylinder 3. In FIG. 1, CL indicates a center line of the inner cylinder 2 and the outer cylinder 3.

The outer cylinder 3 includes a cylindrical side wall portion 7 and a bottom portion 8 that closes one end side of the side wall portion 7 in an axial direction. The inner cylinder 2 has a cylindrical shape. The inner cylinder 2 is engaged with the bottom portion 8 of the outer cylinder 3 via an annular base valve 13 attached to one end part in an axial direction of the inner cylinder 2. The inner cylinder 2 is engaged with the other end side of the side wall portion 7 in the axial direction via an annular rod guide 11 attached to the other end part in the axial direction of the inner cylinder 2.

The base valve 13 is disposed coaxially with the outer cylinder 3, and the rod guide 11 is fitted into the inner cylinder 2 and the outer cylinder 3 to support the other end part of the inner cylinder 2 coaxially with the outer cylinder 3.

An oil seal 15 is disposed on a side of the rod guide 11 opposite to the bottom portion 8 side. A locking portion 16 bent inward is formed on the other end part side of the side wall portion 7 in the axial direction, and the oil seal 15 is supported by the locking portion 16.

A piston 25 is slidably fitted in the inner cylinder 2. The piston 25 divides the inside of the inner cylinder 2 into a first chamber 22 and a second chamber 23. The first chamber 22 is formed between the piston 25 and the rod guide 11, and the second chamber 23 is formed between the piston 25 and the base valve 13. The second chamber 23 is divided from the reservoir chamber R by the base valve 13 provided on one end side of the inner cylinder 2.

The metal piston rod 21 is connected to the piston 25 by a nut 26. The piston rod 21 has a cylindrical large diameter portion 21a and passes through the rod guide 11 and the oil seal 15 to protrude to the outside from one end side of the inner cylinder 2 and the outer cylinder 3. The large diameter portion 21a of the piston rod 21 is slidably inserted into the inside of the rod guide 11 and the inside of the oil seal 15.

A small diameter portion 21b is formed on a distal end side of the piston rod 21, the piston 25 is inserted onto the small diameter portion 21b, the nut 26 is screwed onto a threaded portion at a distal end of the small diameter portion, and thereby the piston 25 is attached to the piston rod 21.

An annular groove 21c is formed in the large diameter portion 21a of the piston rod 21 at a position close to the small diameter portion 21b, and a ring-shaped internal stopper 24 is attached to engage with the annular groove 21c. A ring-shaped rebound rubber 19 is disposed on the internal stopper 24.

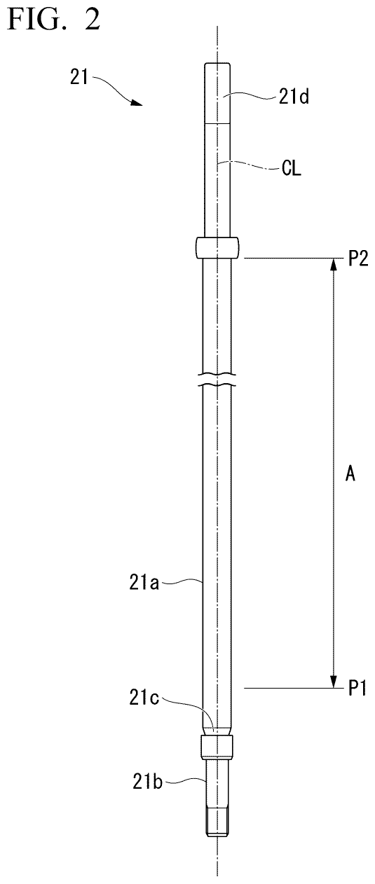

As shown in FIG. 2, in the large diameter portion 21a of the piston rod 21, a portion between a position P1 spaced apart from the annular groove 21c and a connection portion P2 with a bolt portion 21d serving as an attachment portion to a vehicle body is defined as a sliding range A.

A plated film mainly composed of chromium deposited from a trivalent chromium bath to be described in detail later is formed on an outer circumferential surface of the piston rod 21 including the sliding range A.

The piston rod 21 moves together with the piston 25 in the axial direction. The oil seal 15 through which the large diameter portion 21a of the piston rod 21 passes seals a space between the inner cylinder 2 and the outer cylinder 3, and the piston rod 21, and prevents the working fluid in the inner cylinder 2 and the working gas and working fluid in the reservoir chamber R from leaking to the outside.

As shown in FIG. 4, passages 27 and 28 penetrating in the axial direction is formed in the piston 25. As shown in FIG. 1, the passages 27 and 28 allow the first chamber 22 and the second chamber 23 to communicate with each other. An annular disc valve 28a capable of closing the passage 28 by coming into contact with an upper surface of the piston 25 is formed in the piston 25. An annular disc valve 27a capable of closing the passage 27 by coming into contact with a lower surface of the piston 25 is formed in the piston 25.

When the piston rod 21 moves to a compression side (downward in FIG. 1) that increases an amount of entry into the inner cylinder 2 and the outer cylinder 3, the piston 25 moves in a direction in which the second chamber 23 is reduced. When a pressure in the second chamber 23 becomes higher than a pressure in the first chamber 22 by a predetermined value or more, the disc valve 28a opens the passage 28, thereby generating a damping force at that time.

When an upper end side of the piston rod 21 moves to an extension side (upward in FIG. 1) that increases an amount of protrusion from the inner cylinder 2 and the outer cylinder 3, the piston 25 moves in a direction in which the first chamber 22 is reduced. As a result, when a pressure in the first chamber 22 becomes higher than a pressure in the second chamber 23 by a predetermined value or more, the disc valve 27a opens the passage 27, thereby generating a damping force at that time.

As shown in FIG. 1, passages 29 and 29 penetrating the base valve 13 in the axial direction is formed in the base valve 13. The passages 29 allow the second chamber 23 and the reservoir chamber R to communicate with each other. An annular disc valve 30 capable of closing one of the passages 29 by coming into contact with a bottom surface side of the base valve 13 is disposed on the bottom surface side of the base valve 13. An annular disc valve 31 capable of closing the other passage 29 by coming into contact with an upper surface side of the base valve 13 is disposed on the upper surface side of the base valve 13.

The disc valve 30 is a check valve that allows a flow of the working fluid from the second chamber 23 to the reservoir chamber R side through the one passage 29, while restricting a flow of the working fluid through the passage 29 in a direction opposite thereto. The disc valve 30 serves as a valve that opens the passage 29 when the piston rod 21 moves to the compression side and a pressure in the second chamber 23 becomes higher than a pressure in the reservoir chamber R by a predetermined value or more.

The disc valve 31 is a check valve that allows a flow of the working fluid from the reservoir chamber R to the second chamber 23 side through the other passage 29, while restricting a flow of the working fluid through the passage 29 in direction opposite thereto. The disc valve 31 serves as a valve that opens the passage 29 when the piston rod 21 moves to the extension side and a pressure in the second chamber 23 becomes lower than a pressure in the reservoir chamber R by a predetermined value or more.

As shown in FIG. 1, a mounting eye 33 is attached to an outer side of the bottom portion 8. The cylinder device 1 is used by attaching an outer portion of the piston rod 21 and the mounting eye 33 between relative moving members that are objects to be attached.

The cylinder device 1 is used, for example, by connecting the outer end of the piston rod 21 to the vehicle body side and connecting the mounting eye 33 to a wheel side of the vehicle.

In the cylinder device 1, the piston rod 21 and the piston 25 slide integrally in the inner cylinder 2 to change volumes of the first chamber 22 and the second chamber 23. At that time, a damping force can be generated by a flow resistance of the liquid acting on the piston 25 and the base valve 13.

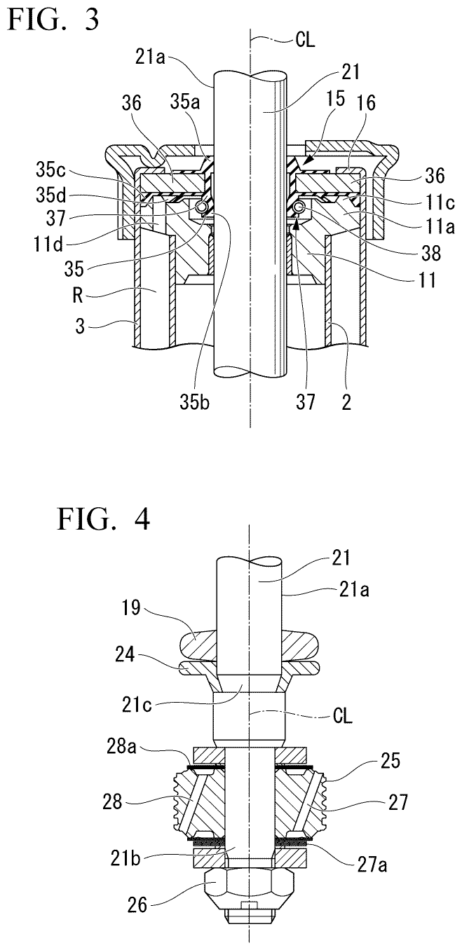

As shown in FIG. 3, the rod guide 11 has a substantially stepped annular shape with a large diameter portion 11a formed on one axial side and a small diameter portion formed on the other axial side. The large diameter portion 11a is fitted into an inner circumferential surface of the outer cylinder 3, and the small diameter portion is fitted into an inner circumferential surface of the inner cylinder 2.

An annular protruding portion 11c protruding in the axial direction is formed at an end part of the large diameter portion 11a of the rod guide 11, and a communication hole 11d that penetrates the rod guide 11 in the axial direction corresponding to a portion of the annular protruding portion 11c is formed. A side of the communication hole 11d opposite to the annular protruding portion side in the axial direction of the rod guide 11 opens to the reservoir chamber R.

The oil seal 15 includes a seal member main body 37 which is an integrally molded product in which an annular member 36 made of a metal is fitted into a seal material 35 made of synthetic rubber, and an annular spring 38 made of a metal. The annular member 36 maintains a shape of the seal material 35 and imparts strength to the seal member main body 37 for fixing it to a target portion. The seal member main body 37 is attached to an end part side of the outer cylinder 3 by sandwiching the annular member 36 between the locking portion 16 and the annular protruding portion 11c.

The seal material 35 includes a dust lip portion 35a, an oil lip portion 35b, a seal ring portion 35c, and a check lip portion 35d, and surrounds a circumference of the piston rod 21 to provide a seal function.

The cylinder device 1 during vehicle travel is configured such that the piston rod 21 or the outer cylinder 3 is repeatedly subjected to impact forces in the axial direction from the outside. Each time an impact force is received, the piston rod 21 moves to the compression side or the extension side, and a damping force acts at that time. In this way, the cylinder device 1 functions as a shock absorber used in a strut-type suspension of an automobile.

Also, a plated film made of chromium deposited from a trivalent chromium bath, which will be described below, is provided on the outer circumferential surface of the piston rod 21. This plated film is a plated film that is less susceptible to brittle fracture (tearing failure) when the outer circumferential surface of the piston rod 21 is subjected to outer diameter polishing to achieve a desired surface roughness during manufacture. If the piston rod 21 has an outer circumferential surface that is finished to a polished surface with the desired surface roughness and has a plated film to be described in detail later, excellent sliding characteristics can be exhibited and superior wear resistance can be obtained even if the large diameter portion 21a of the piston rod 21 repeatedly slides against the seal material 35.

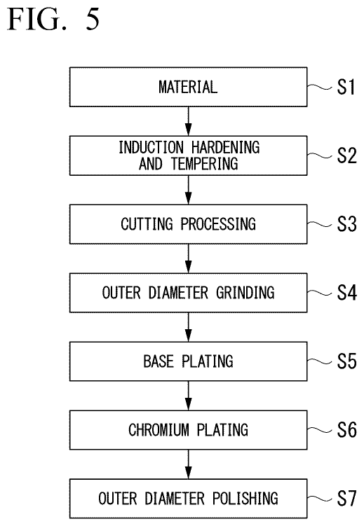

FIG. 5 is a flowchart showing an example of a manufacturing process for the piston rod 21.

As shown in step S1 of FIG. 5, a rod material such as a steel rod made of a steel material of a required type for forming the piston rod 21 is prepared.

The rod material is subjected to a heat treatment such as induction hardening and tempering in step S2 to apply a surface hardening treatment suitable for a piston rod.

Next, in step S3, cutting processing is performed to obtain an approximate shape shown in FIGS. 1 to 4, and in step S4, an outer diameter grinding processing is performed.

Next, the piston rod having the approximate shape shown in FIGS. 1 to 4 is subjected to a base plating treatment such as nickel plating in step S5, and then to a chromium plating treatment mainly composed of chromium deposited from a trivalent chromium bath in step S6. Further, in step S5 in which the base plating treatment is performed, other base plating treatment may be performed instead of the nickel plating, or step S5 of performing the base plating treatment may be omitted to omit the base plating.

Next, in step S7, outer diameter polishing of the piston rod is performed, precision finishing is performed, and thereby a piston rod with a final surface shape can be obtained.

The present embodiment is characterized by the plating treatment performed in step S6 and the chromium-plated film, which is mainly composed of chromium deposited from a trivalent chromium bath, formed on the piston rod.

The chromium-plated film deposited from the trivalent chromium bath used in the present embodiment is mainly composed of chromium and contains, as other elements, one or more impurity elements selected from carbon (C) and oxygen (O).

For example, the chromium-plated film preferably contains 60 to 80 at % of chromium and 16.5 to 30 at % of carbon with a surface indentation hardness of 7 GPa or more.

However, the indentation hardness indicates a value obtained by instrumented indentation hardness measurement conducted using a nanoindentation method (ISO 14577). For example, an indentation load of 20 mN can be applied.

Of the above-described elements, the chromium-plated film may contain oxygen in an amount of about 2 to 6 at %. Further, in addition to the above-described elements, the chromium-plated film may contain either chlorine (Cl) or iron (Fe) as an impurity element in an amount of about 5 at % or less.

Also, the carbon content described above is more preferably about 18 to 25 at %, and the oxygen content is more preferably about 2 at % to 5 at %.

The main component of the plated film is chromium, and it is desirable for it to be contained as much as possible. Although the carbon contained in the plated film is thought to originate from organic components constituting the plating bath as will be described below, if the carbon content is less than 16.5 at %, it is thought that there is a higher likelihood of brittle-mode tearing marks occurring during the outer diameter polishing. Based on an upper limit of a concentration of organic salts added to the plating bath, a maximum carbon content that can be contained in the plated film is considered to be 30 at %.

The oxygen content in the plated film is in a range of 2 at % to 6 at %.

If the oxygen content is less than 2 at %, there is a problem in that a likelihood of occurrence of brittle-mode tearing marks will increase, and if the oxygen content exceeds 6 at %, there is a problem in that a likelihood of occurrence of brittle-mode tearing marks will increase to the same extent as above.

In the plated film of the present embodiment, an elemental analysis can be performed using an electron probe micro analyzer (EPMA), and conditions such as, for example, an acceleration voltage of 10 kV and an irradiation current of 100 nA can be employed.

Further, in the present specification, when a numerical range is defined and an upper limit value and a lower limit value are indicated with “to,” the concept is to be understood as including the upper limit value and the lower limit value unless otherwise specified. Therefore, the above-described 60 to 80 at % means a range of 60 at % or more and 80 at % or less.

The above-described impurity elements other than chromium are presumed to originate from organic components included in the plating bath such as a carboxylate, a pH buffer, and a conductivity salt to be described below.

In the chromium-plated film according to the present embodiment, an impurity content in the plated film varies depending on plating treatment conditions, and it is considered that a current density, a bath temperature, and a pH condition contribute to the impurity content.

The reason why these serves as causes is presumably that incorporation of additives during chromium deposition is affected by a current density (reduction rate), a bath temperature (reduction rate), and pH (complex formation and reduction rate).

### [Film Structure of Hard Trivalent Chromium-Plated Film Analyzed by TEM]

A structure of the plated film of the present embodiment is preferably such that a grain size of oriented chromium crystals is less than 10 nm and a base material is preferably unoriented microcrystals. Also, it is desirable that there be no chromium diffraction spots at positions corresponding to an inter-lattice plane distance d value of 2.0 to 2.2 Å (chromium d value: 2.04 Å) in an electron diffraction pattern.

The structure of the plated film varies according to plating treatment conditions, and it can be ascertained in examples to be described later that, particularly, a current density, a bath temperature, and a pH condition significantly contribute to the variation. This is presumably because incorporation of additives during chromium deposition affects a current density (reduction rate), a bath temperature (reduction rate), and a pH (complex formation).

A scanning transmission electron microscope (STEM) can be employed to observe the structure of the plated film of the present embodiment, and conditions such as an acceleration voltage of 200 kV or the like can be selected.

When obtaining an electron diffraction pattern, measurement conditions thereof such as an acceleration voltage of 200 kV, an electron beam wavelength 2 of 0.00251 nm at 200 kV, and a camera length of 399.4 mm can be employed.

In the present embodiment, the plating bath used in the chromium plating treatment can use a plating bath containing components such as a trivalent chromium salt, a complexing agent as an additive, a pH buffer, and a conductivity salt.

As the trivalent chromium salt, chromium chloride, chromium sulfate, basic chromium sulfate, and the like can be used, and among these, it is preferable to use chromium chloride.

As the complexing agent, carboxylates such as glycine, formic acid, oxalic acid, acetic acid, and the like can be used, and among these, it is preferable to use glycine.

As the pH buffer, boric acid, citric acid, and the like can be used, and among these, it is preferable to use boric acid.

As the conductivity salt, ammonium chloride, ammonium sulfate, ammonium sulfonate, and the like can be used, and among these, it is preferable to use ammonium chloride.

When a strongly acidic trivalent chromium bath is used as the plating bath, it is desirable to select a strong acidity weaker than pH 0.1, for example, a strong acidity in a range of pH 0.1 to pH 0.6, and more preferably a strong acidity in a range of pH 0.2 to pH 0.5.

If it is a strong acidity of pH 0.1 or lower, it becomes difficult to obtain the plated film mainly composed of chromium deposited from the trivalent chromium bath as intended in the present application, and if the pH exceeds 0.6, the plated film mainly composed of chromium deposited from the trivalent chromium bath as intended in the present application cannot be obtained due to reasons such as poor gloss of the plated film and changes in incorporation of impurity elements during chromium deposition caused by variations in film formation rate.

When a weakly acidic trivalent chromium bath is used as the plating bath, Blue Chromium (trade name manufactured by Atotech) can be used as an example of a commercially available product. When Blue Chromium is used, a pH range of 5.2 to 5.8 can be selected as an example. The pH is more preferably in a range of 5.4 to 5.6.

In the present embodiment, when the trivalent chromium plating solution Blue Chrome made by Atotech is used, the plating bath used in the chromium plating treatment can use a plating bath containing components such as a trivalent chromium salt, a complexing agent as an additive, a pH buffer, and a conductivity salt.

As the trivalent chromium salt, chromium chloride, chromium sulfate, basic chromium sulfate, and the like can be used, and among these, it is preferable to use chromium sulfate.

As the complexing agent, carboxylates such as glycine, formic acid, oxalic acid, acetic acid, and the like can be used, and among these, it is preferable to use formic acid.

As the pH buffer, ammonia, boric acid, citric acid, and the like can be used, and among these, it is preferable to use ammonia.

As the conductivity salt, ammonium chloride, ammonium sulfate, ammonium sulfonate, and the like can be used, and among these, it is preferable to use ammonium sulfate.

A pH of the plating bath is preferably acidic, and it is desirable to select an acidity that is weaker than pH 6.0, for example, an acidity in a range of pH 5.3 to pH 5.7.

If the acidity is pH 5.3 or lower, the plated film mainly composed of chromium deposited from the trivalent chromium bath as intended in the present application cannot be obtained, and if the pH exceeds 5.7, there is a likelihood that the plated film mainly composed of chromium deposited from the trivalent chromium bath as intended in the present application cannot be obtained due to reasons such as poor gloss of the plated film and changes in incorporation of impurity elements during chromium deposition caused by variations in film formation rate.

A higher current density during the plating treatment results in a faster film formation rate and leads to better productivity, but to achieve the above-described composition, a current density in a range of 45 to 100 A/dm² can be selected. The film formation rate increases under conditions of a high current density and high concentration of the trivalent chromium salt, but the incorporation of impurity elements when chromium is deposited changes due to variations in the film formation rate. It is desirable to set a suitable film formation rate to obtain the desired chromium content and the carbon content described above in the resulting plated film.

Further, a higher plating bath temperature is desirable, and a range of, for example, 55° C. to 80° C. can be selected.

As an agitation method for the plating bath, a gentle agitation method such as causing a plating solution to flow in the vicinity of a surface to be plated is desirable. As for an anode material, those having satisfactory insolubility such as Pt, Ti, Ir, and graphite can be used.

A higher current density during the plating treatment results in a faster film formation rate and leads to better productivity, but to achieve the above-described composition, a current density in a range of 45 to 100 A/dm² can be selected. The film formation rate increases under conditions of a high current density and high concentration of the trivalent chromium salt, but the incorporation of impurity elements when chromium is deposited changes due to variations in the film formation rate. It is desirable to set a suitable film formation rate to obtain the desired chromium content and the carbon content described above in the resulting plated film.

Further, a higher plating bath temperature is desirable, and a range of, for example, 55° C. to 80° C. can be selected.

As an agitation method for the plating bath, a gentle agitation method such as causing a plating solution to flow in the vicinity of a surface to be plated is desirable. As for an anode material, those having satisfactory insolubility such as Pt, Ti, Ir, and graphite can be used.

The plated film deposited from the trivalent chromium bath formed by the above-described plating treatment has an amorphous structure during film formation. This plated film having an amorphous structure may be subjected to a heat treatment at a heating temperature of 200° C. or lower to form an amorphous plated film having a degree of crystallinity of, for example, 4% or less, preferably 2% or less, and more preferably 1% or less.

A degree of crystallinity is a value calculated from a peak integrated intensity ratio of a measured value of X-ray diffraction measurement and the following expression (1).

$$Degree of crystallinity ( peak integrated intensity ratio ) = \{ \text{} ( Crystalline ) / ( Crystalline + Amorphous ) \} \times 100 \% \qquad Expression ( 1 )$$

Here, the integrated intensity ratio in expression (1) indicates a value determined in an X-ray diffraction (XRD) analysis under conditions of 20:30° to 60°, a half width of crystalline: <3, and a half width of amorphous: ≥3.

In the present specification, a plated film with a degree of crystallinity of 0% obtained according to the following expression (1) is determined to be amorphous, and a plated film with a degree of crystallinity of 4% or less includes the concept of the plated film with a degree of crystallinity of 0%.

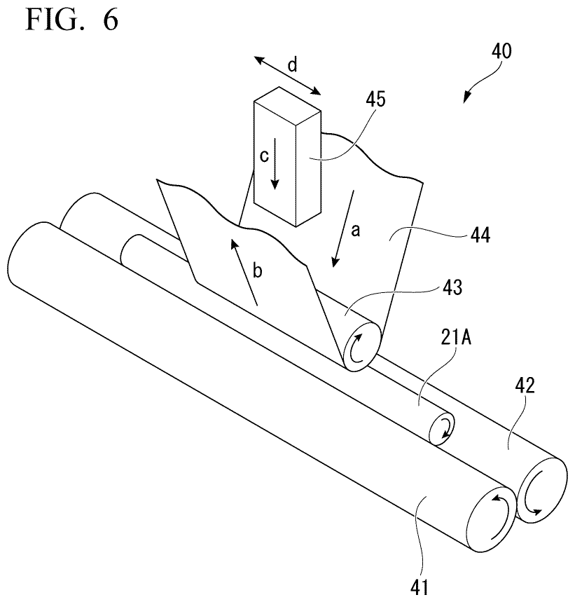

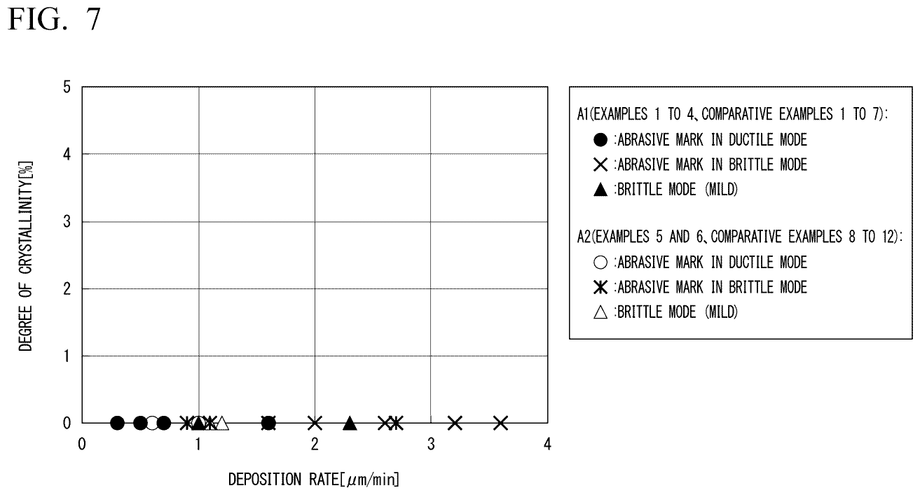

It is desirable that the plated film of the present embodiment do not easily generate abrasive marks due to a brittle mode when polishing processing is performed. For example, abrasive marks caused when polishing is performed using a film polishing device shown in FIG. 6 will be observed.

A film polishing device 40 shown in FIG. 6 includes drive rollers 41 and 42 disposed close to each other horizontally to be rotatable around their respective axes with portions of their circumferential surfaces in close proximity to each other, and is configured so that a rod material 21A for the piston rod to be processed can be placed on a boundary portion between these adjacent drive rollers 41 and 42.

When the rod material 21A is placed on the boundary between the drive rollers 41, 42 that are arranged close to each other, the supported rod material 21A can be rotated around its axis as the drive rollers 41, 42 rotate.

A backup roller 43 that is rotatable around the circumference is disposed horizontally above the rod material 21A on the boundary portion between the drive rollers 41 and 42, and it is configured such that a polishing film 44 can be supplied to a bottom surface side of the backup roller 43 from a film supply device (not shown).

The polishing film 44 is a band-shaped film and can be supplied to the bottom surface side of the backup roller 43 from the film supply device (not shown) provided on one side of the backup roller 43 in a direction perpendicular to a central axis thereof as indicated by arrow a. Also, the film 44 can be moved to a film winding device (not shown) provided on the other side of the backup roller 43 in a direction perpendicular to the central axis and wound up as indicated by arrow b. The polishing film 44 can be wound onto the film supply device by a required length and continuously supplied to the bottom surface side of the backup roller 43.

The backup roller 43 is supported by a vertical movement mechanism (not shown) to be rotatable while maintaining a horizontal state, but is also supported by the vertical movement mechanism so that a vertical position thereof can be finely adjusted. A pressing head 45 supported by a vertical and horizontal movement mechanism (not shown) is provided above the backup roller 43. The pressing head 45 can press the backup roller 43 downward with a predetermined pressing force while descending from a position slightly above the backup roller 43 as indicated by arrow c. Also, the pressing head 45 is also supported to be movable in the axial direction of the backup roller 43 as indicated by arrow d by the above-described vertical and horizontal movement mechanism, and the pressing head 45 is supported to be reciprocally movable in the axial direction of the backup roller 43 while maintaining a state of pressing the backup roller 43 downward with a predetermined force.

A polishing test of the piston rod is conducted using three film polishing devices shown in FIG. 6 with, for example, a #600 polishing film loaded in a first film polishing device, a #400 polishing film loaded in a second film polishing device, a #1000 polishing film loaded in a third film polishing device, and a #2000 polishing film loaded in a fourth film polishing device.

Further, polishing conditions for these are equivalent to the polishing conditions applied to sample 1 shown in FIG. 28 of PCT International Publication No. WO 2021/193107. During polishing, a rotation speed of the drive rollers 41 and 42 was set to 1400 rpm, and a pressing force by the pressing head 45 was set to 0.15 to 0.3 MPa. The steel rod used for the test may have a diameter of 22 mm and a length of 200 mm.

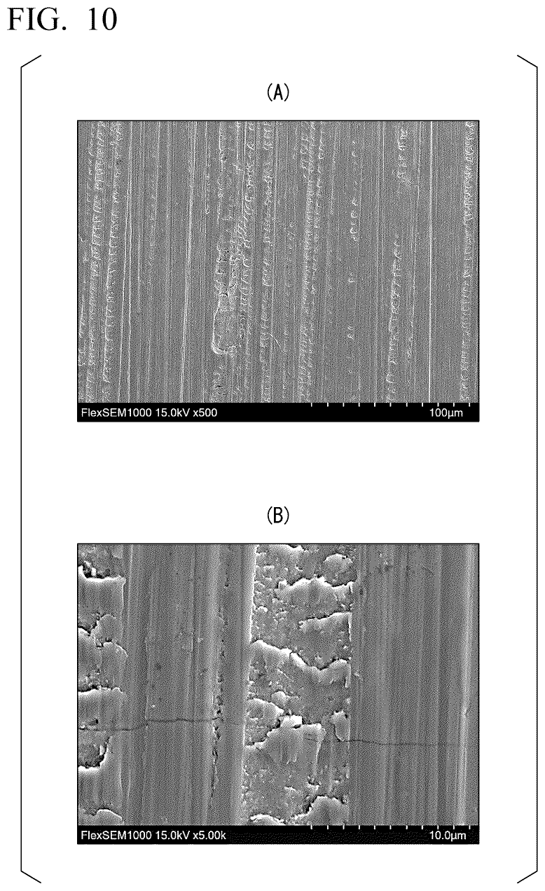

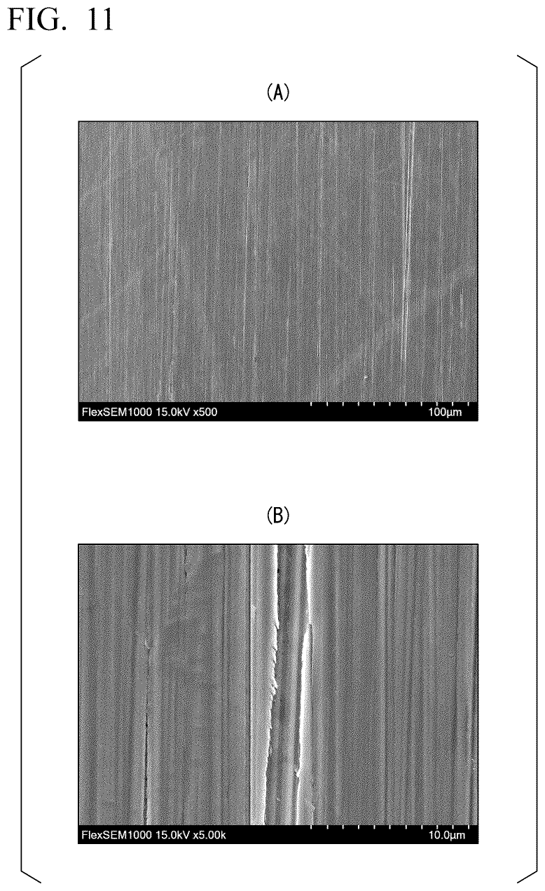

When the above-described polishing processing is performed, as an example, resulting samples will be those shown in examples and comparative examples to be described later such as, for example, either a sample with abrasive marks in brittle mode as shown in FIGS. 10(A) and 10(B) or a sample with abrasive marks in ductile mode as shown in FIGS. 11(A) and 11(B).

The abrasive marks shown in FIGS. 10(A) and 10(B) are from a sample having abrasive marks in brittle mode that exhibit tearing marks caused by brittle fracture as is clear from the enlarged image of FIG. 10(B).

The abrasive marks shown in FIGS. 11(A) and 11(B) are from a sample having abrasive marks in ductile mode that do not have tearing marks as is clear from the enlarged image of FIG. 11(B).

If the plated film that generates the abrasive marks shown in FIGS. 10(A) and 10(B) is used as the plated film of the piston rod 21 shown in FIGS. 1 to 4, abrasive marks in brittle mode that exhibit tearing marks are generated on the surface when the outer diameter polishing in step S7 shown in FIG. 5 is performed, and it will not be possible to achieve a desired surface roughness.

The film polishing device 40 shown in FIG. 6 is a device for finishing the outer circumferential surface of the piston rod, and is a device that performs polishing that is important for finishing the outer circumferential surface of the piston rod to a desired surface roughness. If the above-described abrasive marks in brittle mode are generated during the outer diameter polishing, it adversely affects a finishing accuracy of the outer circumferential surface of the piston rod, making it impossible to achieve excellent sliding characteristics, wear resistance, and corrosion resistance.

Therefore, for the sample in which the above-described polishing test was performed as the plated film provided on the piston rod 21 applied in the present embodiment, for example, abrasive marks on the surface are observed under a microscope at a magnification of 200 times. Then, it is preferable to use a plated film selected after measuring the number and a width of abrasive marks in the same field of view, determining the number of abrasive marks with a width of 8 μm or more, and evaluating quality of the plated film based on the number of abrasive marks generated.

Further, the reason why abrasive marks with a width of 8 μm or more were used as the evaluation criterion is that, when polishing tests were conducted on a plurality of samples in the examples to be described later, abrasive marks in brittle mode in which tearing marks were generated were mostly 8 μm or more in width.

From results of the examples to be described later, it is desirable to use a chromium-plated film which contains, in addition to chromium, one or more impurity elements selected from carbon and oxygen, containing 60 to 80 at % of chromium and 16.5 to 30 at % of carbon, and having an indentation hardness of 7 GPa or more on an outer surface.

When a strongly acidic plating bath containing, for example, the above-described trivalent chromium salt, carboxylate, pH buffer, and conductivity salt is used, the above-described chromium-plated film can be obtained by performing a plating treatment under conditions of a pH of 0.1 to 0.6, a bath temperature of 55 to 80° C., and a cathode current density of 45 to 100 A/dm².

The plated film formed on the outer circumferential surface of the piston rod 21 under the above-described conditions has a plating hardness of 7 GPa or more. If the above-described plated film has a plating hardness of 7 GPa or more, even if the outer diameter polishing is performed under the above-described conditions using the film polishing device 40 shown in FIG. 6, it is less likely to generate tearing marks (fracture marks due to the brittle mode).

Also, if the above-described plated film has a composition containing 60 to 80 at % of chromium and 16.5 to 30 at % of carbon, even if the outer diameter is polished under the above-described conditions using the film polishing device 40 shown in FIG. 6, it is less likely to generate tearing marks.

Therefore, even if the above-described polishing processing is performed, the piston rod 21 without tearing marks can be obtained.

Incidentally, in the above-described embodiment, a plated member with a plated film deposited from a trivalent chromium bath formed on the piston rod 21 has been described, but, in addition to this, the plated film may also be applied to sliding surfaces of various slide members including automobile parts such as piston rings and brake pistons, as well as shafts of hydraulic equipment and gravure rolls of printing equipment.

### EXAMPLES

A plurality of steel rods (diameter 22 mm, length 200 mm) made of low-carbon steel were prepared as test materials, and a strongly acidic plating bath (hereinafter abbreviated as A1) to which chromium chloride, glycine, boric acid, and ammonium chloride were added was used as a trivalent chromium plating bath.

In a case of the A1 bath, a plating treatment was performed under conditions of a bath temperature of 65 to 75° C., a current density of 50 to 90 A/dm², and a pH of 0.3 to 0.46 to form a chromium-plated film with a thickness of about 20 μm on a surface of the test material.

When a chrome plating bath (hereinafter abbreviated as A2) made of weakly acidic Blue Chrome (trade name manufactured by Atotech) was used as the trivalent chrome plating bath, a plating treatment was performed under conditions of a bath temperature of 48 to 60° C., a current density of 40 to 90 A/dm², and a pH of 5.39 to 5.65 to form a chromium-plated film with a thickness of about 20 μm on the surface of the test material.

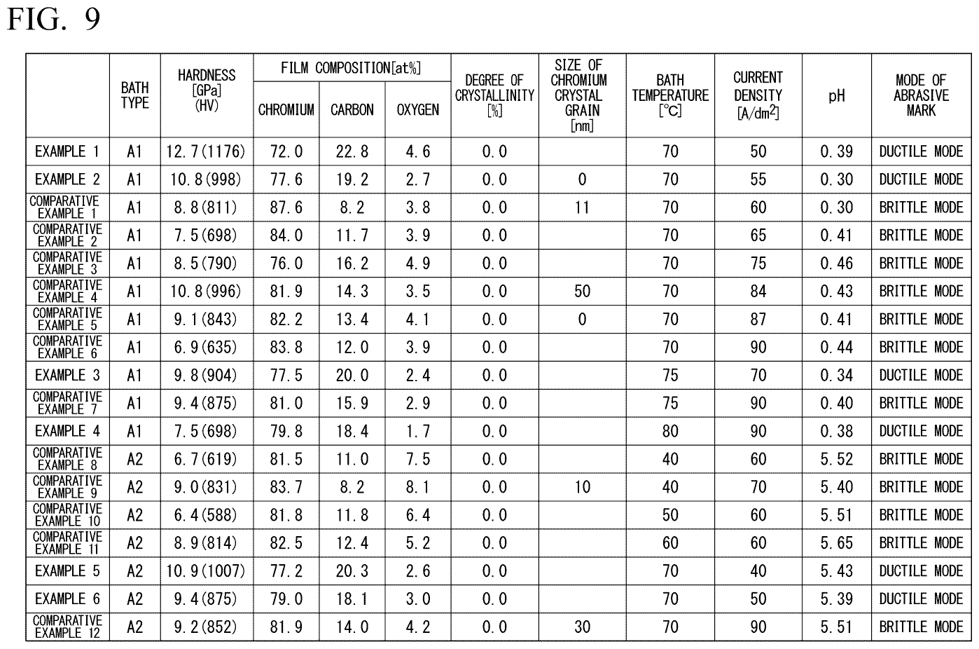

FIG. 7 shows results of determining a degree of crystallinity (%) of each plated film based on the above-described expression (1) when plated films of examples 1 to 6 and comparative examples 1 to 12 shown later in FIG. 9 were formed at various deposition rates (film formation rates) by adjusting the current density. In all the deposition rates, since only a halo pattern was observed in a range of 20:30 to 60° in X-ray diffraction (XRD) analysis results, the plated films in their as-formed state were found to be amorphous films with a degree of crystallinity of 0.0%.

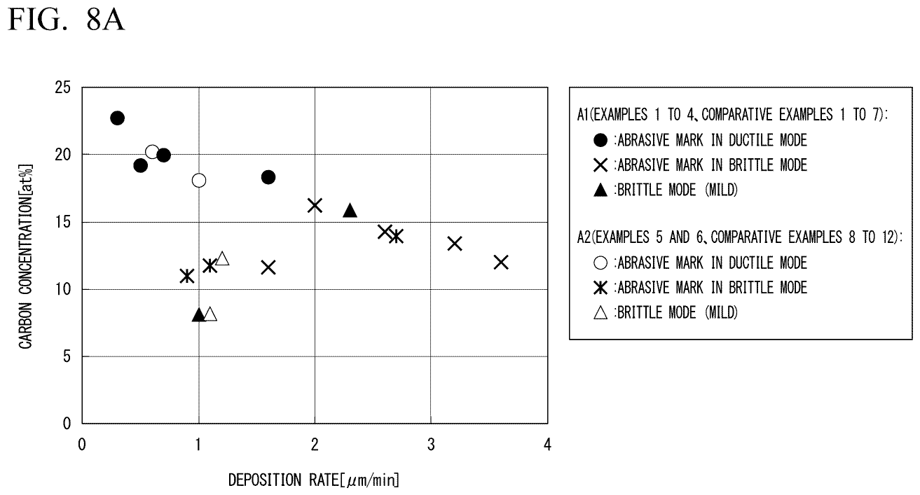

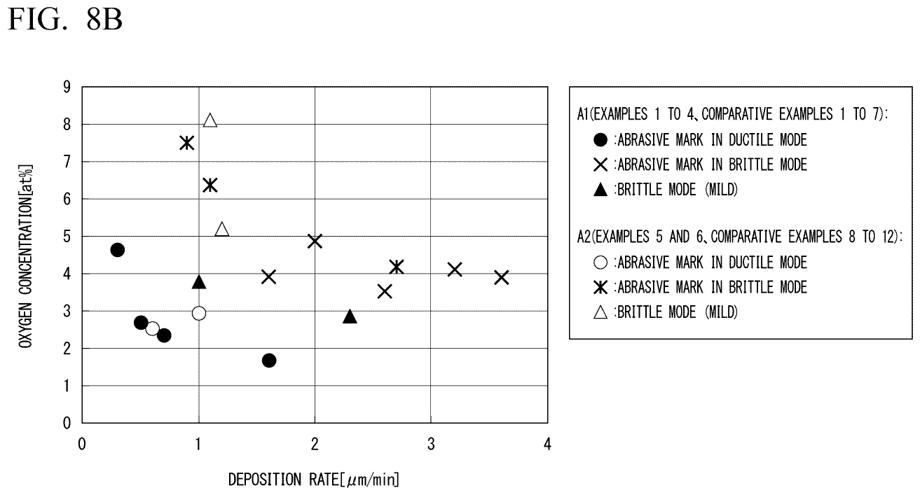

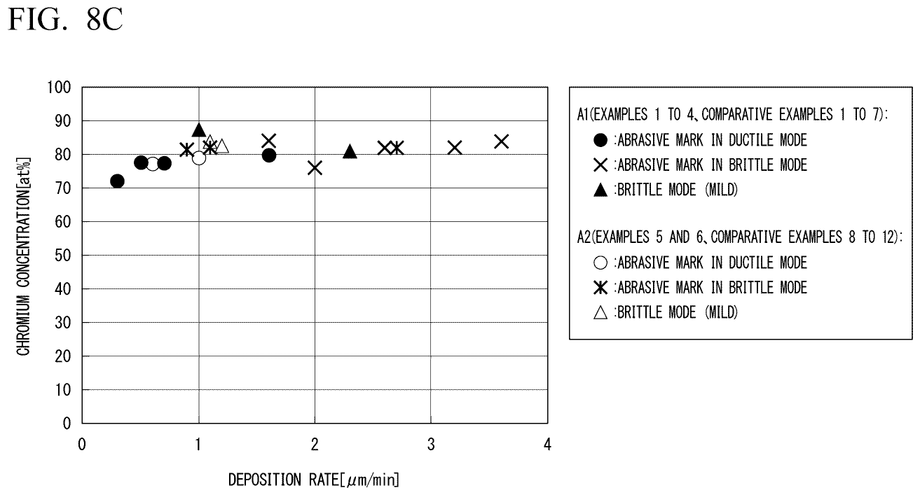

FIGS. 8A to 8C show results of component analysis of the plated films of examples 1 to 6 and comparative examples 1 to 12 shown later in FIG. 9. The component analysis was conducted using an electron probe microanalyzer under conditions of an acceleration voltage of 10 kV and an irradiation current of 100 nA.

It was possible to ascertain that the plated films deposited from the trivalent chromium bath formed at various film formation rates contained carbon as an impurity element as shown in FIG. 8A, contained oxygen as shown in FIG. 8B, and contained approximately 80 at % of chromium as shown in FIG. 8C.

FIG. 9 shows a film composition. Of the impurity elements in the film composition of examples 1 to 6, carbon, which had the highest content, was contained at about 18 to 23 at %, and oxygen, the second most abundant, was contained at about 1.5 to 5 at %. Specifically, carbon was contained at 18.1 to 22.8 at %, and oxygen was contained at 1.7 to 4.6 at %.

From FIGS. 8 and 9, it can be seen that the carbon content can be adjusted by adjusting the deposition rate (film formation rate) of the plated film. Further, the deposition rate can be selected to conditions of about 0.2 to 4 μm/min or faster, and can also be adjusted by the amount of chromium chloride added to the chromium plating bath. Therefore, it can be recognized that the carbon content can be adjusted within a range of 8 to 30 at % by adjusting the plating conditions.

Indentation hardnesses of the plated films were measured for the plurality of plated films, and results of component analysis of the samples whose hardness was measured are shown in FIG. 9. However, the indentation hardness refers to a value obtained by instrumented indentation hardness measurement using a nanoindentation method (ISO 14577). An indentation load was set to 20 mN.

In FIG. 9, samples with an indentation hardness of the outer surface of 7.5 GPa or more and a carbon content of 16.5 at % or more are indicated as examples, and samples not satisfying the above-described conditions are indicated as comparative examples. Also, samples produced using a strongly acidic plating bath is indicated as a bath type A1, and samples produced using a weakly acidic plating bath is indicated as bath type A2. Since these plated films were all determined to be amorphous films in XRD analysis results, a degree of crystallinity is indicated as 0.0%.

The samples of examples 1 to 6 shown in FIG. 9 had an indentation hardness of 7.5 GPa or more, and when the polishing test described below was conducted, the abrasive marks were determined to be in the ductile mode, and thus “Ductile mode” was indicated in a column of “Abrasive mark mode” in FIG. 9.

The samples of comparative examples 1 to 12 shown in FIG. 9 were samples with a hardness of less than 16 GPa or a carbon content outside the range of 16.5 to 30 at %, but when the polishing test described below was conducted, the abrasive marks were determined to be in the brittle mode, and thus “Brittle mode” was indicated in the column of “Abrasive mark mode” in FIG. 9.

### “Polishing Test”

A polishing test of the piston rod was conducted using four film polishing devices shown in FIG. 6 with a #600 polishing film loaded in a first film polishing device, a #400 polishing film loaded in a second film polishing device, and a #2000 polishing film loaded in a third film polishing device.

Further, polishing conditions for these are equivalent to the polishing conditions applied to sample 2 shown in FIG. 28 of PCT International Publication No. WO 2021/193107. During polishing, a rotation speed of the drive rollers 41 and 42 was set to 1400 rpm, and a pressing force by the pressing head 45 was set to 0.15 to 0.3 MPa.

An image of a surface of the piston rod of comparative example 1 captured after the polishing test at a magnification of 500 times using a scanning electron microscope is shown in FIG. 10(A), and an image captured at a magnification of 5000 times is shown in FIG. 10(B).

An image of a surface of the piston rod of example 1 captured after the polishing test at a magnification of 500 times using a scanning electron microscope is shown in FIG. 11(A), and an image captured at a magnification of 5000 times is shown in FIG. 11(B). Vertical streaks extending in a vertical direction can be observed in FIGS. 10 and 11, and traces of the polishing that were made as the polishing film is moved in a direction of the vertical streaks can be seen.

As shown in the enlarged view of FIG. 10(B), in a sample of comparative example 1, abrasive marks (tearing marks) that are thought to be tearing fractures caused by brittle fracture are generated in a movement direction of the polishing film.

In contrast, as shown in the enlarged view of FIG. 11(B), a sample of example 1 has flow-shaped abrasive marks in the movement direction of the polishing film that are generated due to shear deformation.

For the piston rods of the examples and the comparative examples, the number and widths of friction marks present within a 200× magnification field of view were observed using an optical microscope at three locations each using an optical microscope.

As a result, a plurality of abrasive marks with a width of 8 μm or more could be observed in all of the comparative samples, and it was possible to ascertain that tearing fractures occurred in the abrasive marks with a width of 8 μm or more. Also, in the example samples, abrasive marks with tearing marks were not observed.

From the above results, when the above-described polishing test was conducted on the plated films, it was determined that measuring the number of abrasive marks with a width of 8 μm or more serves as an indicator of whether the plated film exhibits a brittle mode or a ductile mode in the above-described polishing test.

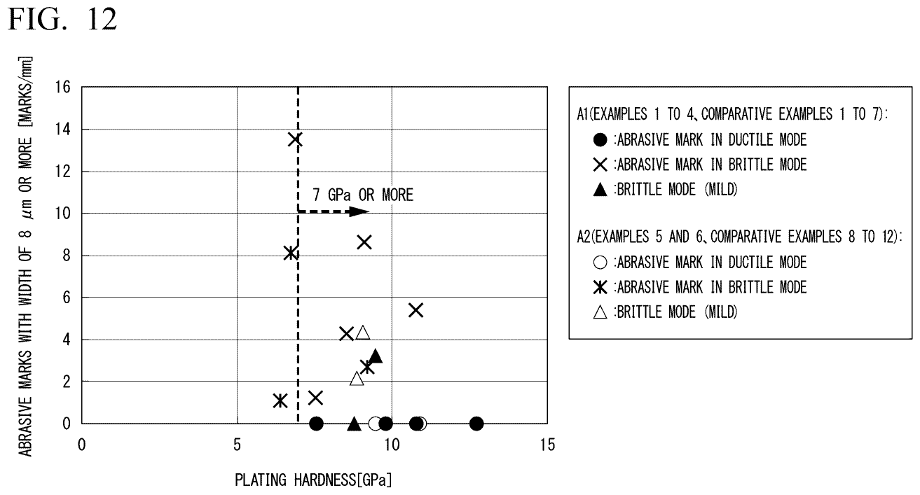

FIG. 12 shows results of measuring a plating hardness (GPa) and the number of abrasive marks (marks/mm) with a width of 8 μm or more for the samples of examples 1 to 6 and samples of comparative examples 1 to 12.

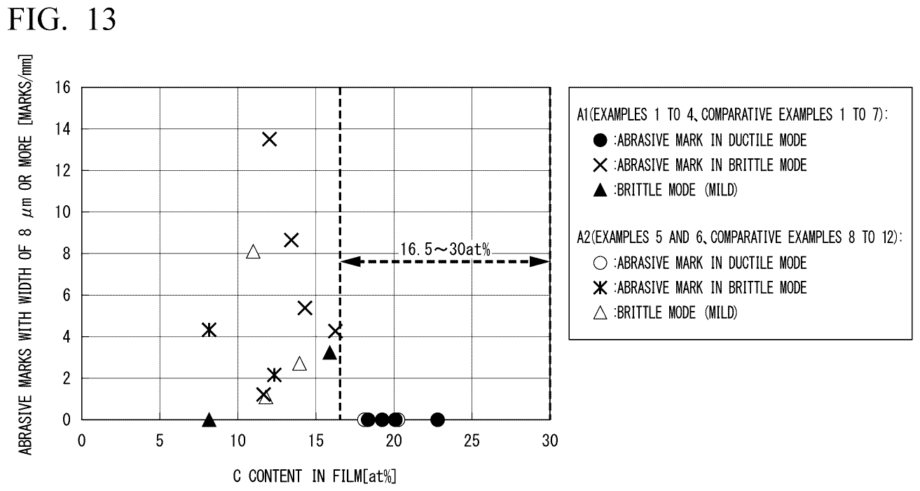

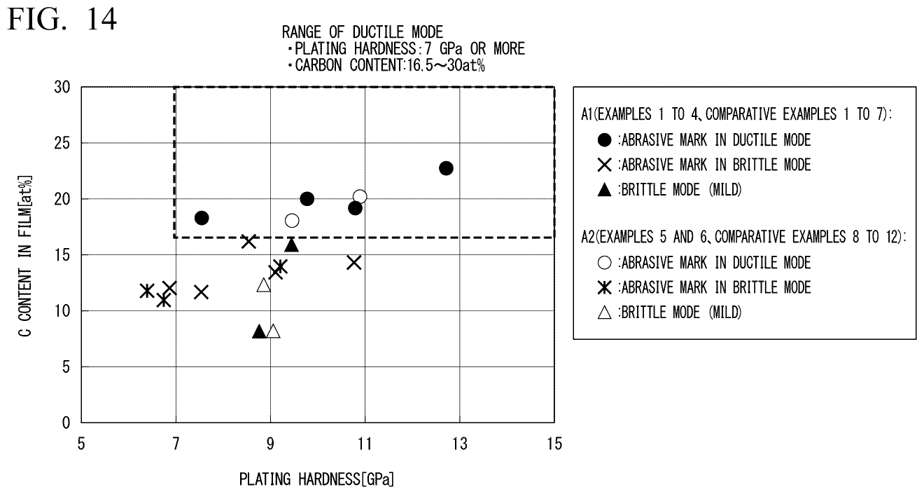

FIG. 13 shows results of measuring a carbon content (at %) in the film and the number of abrasive marks (marks/mm) with a width of 8 μm or more for the samples of examples 1 to 6 and samples of comparative examples 1 to 12.

FIG. 14 shows a correlation between a plating hardness and a carbon content in the film based on the results shown in FIGS. 12 and 13.

As shown in FIG. 12, it is found that generation of abrasive marks in brittle mode decreases when the plating hardness is 7.5 GPa or more with a boundary being around 7.5 GPa. On the other hand, only abrasive marks in brittle mode are generated in a range of 5 to 7 GPa.

As shown in FIG. 13, it is found that generation of abrasive marks in brittle mode disappears at a carbon content of approximately 16.5 at %, which serves as the boundary. On the other hand, in a range of less than 16 at %, slight abrasive marks in brittle mode and abrasive marks in brittle mode were generated.

In view of these results, as shown in FIG. 14, it is found that, when the piston rod is polished by the above-described polishing test, a plated film containing 16.5 at % or more of carbon and having an indentation hardness of the outer surface of 7 GPa or more is desirable. These plated films can be determined to be plated films deposited from a trivalent chromium bath not producing tearing marks and featuring primarily abrasive marks in ductile mode.

Further, considering that an amount of carbon that can be incorporated into the plated film is limited to approximately 30 at % due to an amount of organic components added to the plating bath, an effective carbon content of the plated film is considered to be in a range of 16.5 to 30 at %. With a carbon content within the range, a hardness of the plated film can be achieved in a range of 7 to 15 GPa as shown in FIG. 14.

On the other hand, when a hardness of the plated film is in a range of 6.0 to 6.9 GPa and a carbon content is in a range of 10 to 16 at %, abrasive marks in brittle mode are generated as described above. Further, even when the plating hardness is 6.9 GPa or more, in a range of carbon content less than 15 at %, it is considered to exhibit a brittle mode or an asymptotic mode before changing to a ductile mode. It is considered that the changes in each range are considered to result from formation of films with different chromium carbides, leading to variations in the plating hardness and carbon content shown in each range accordingly.

From these results, it is considered that film properties are derived from organic components such as a carboxylate, a pH buffer, and a conductivity salt in the plating bath. Furthermore, it is considered that an amount of organic components incorporated into the film also changes according to conditions of a pH, a bath temperature, and a current density during plating.

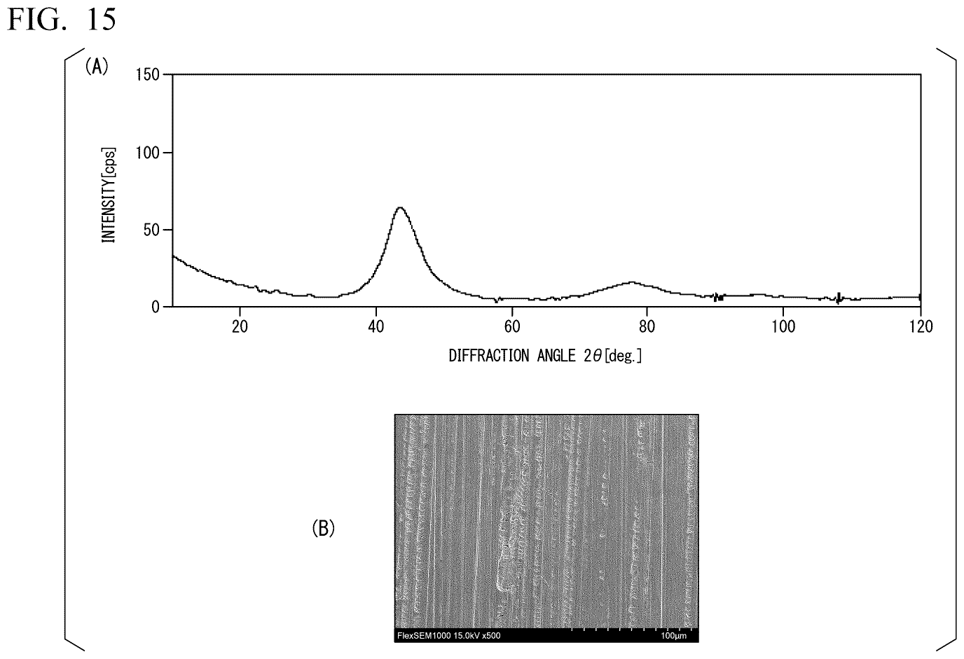

FIG. 15 (A) shows X-ray diffraction analysis results of the sample of comparative example 1, and FIG. 15 (B) is a surface image of the same sample at a magnification of 200 times showing abrasive marks. In the surface image shown in FIG. 15 (B), three abrasive marks (accompanied by tearing fractures) with a width of 8 μm or more can be identified in the areas in front of the arrows.

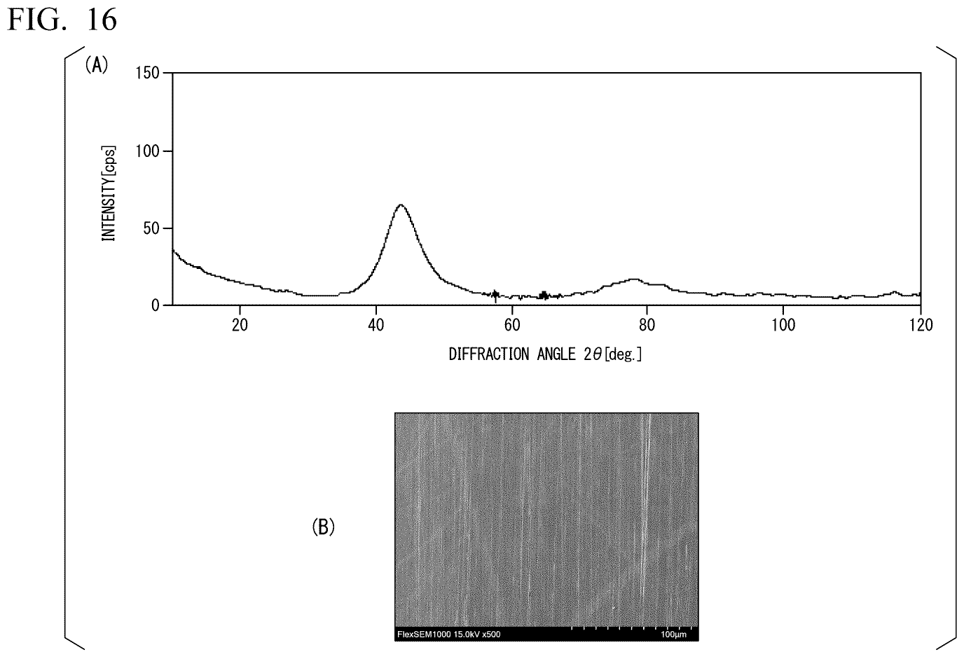

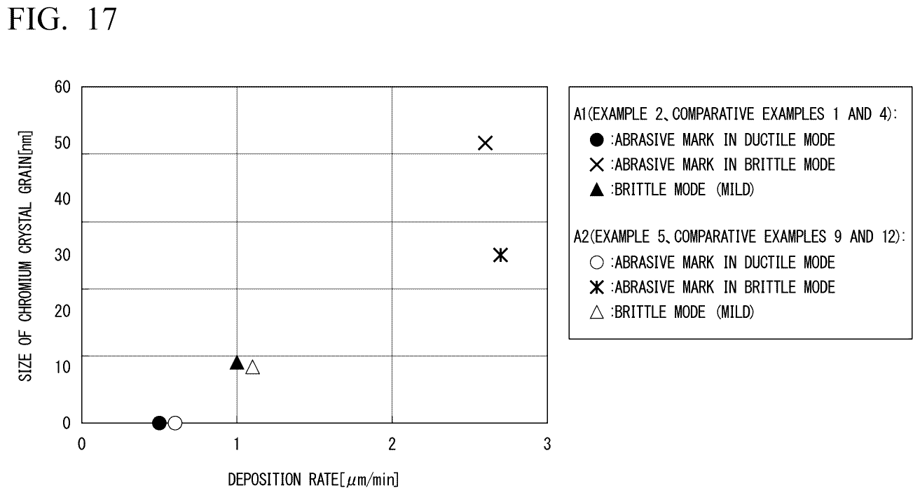

FIG. 16 (A) shows X-ray diffraction analysis results of the sample of example 1, and FIG. 16 (B) is a surface image showing abrasive marks on the same sample.

From the X-ray diffraction analysis results shown in FIG. 15 (A), it can be seen that the sample of comparative example 1 is a 100% amorphous sample (degree of crystallinity of 0.0%) exhibiting only a halo pattern. On the other hand, from the X-ray diffraction analysis results shown in FIG. 16 (A), it can be seen that the sample of example 1 is a 100% amorphous sample (degree of crystallinity of 0.0%) exhibiting only a halo pattern. This sample had a carbon content of 22.8 at %, which is higher than 16.5%, and a hardness of 12.7 GPa, which is equal to or larger than 7 GPa, resulting in a ductile mode.

According to the above-described expression (1), Degree of crystallinity (peak integrated intensity ratio)={(Crystalline)/(Crystalline+Amorphous)}×100%, the integrated intensity ratio of expression (1) is determined in FIG. 16 (A) under conditions of 2θ:30° to 60°, a half width of crystalline: <3, and a half width of amorphous: ≥3.

From the X-ray diffraction analysis results shown in FIG. 16 (A), a degree of crystallinity calculated on the basis of expression (1) is 0.0%.

In the sample shown in FIG. 16 (B), large-width abrasive marks contained in the structure shown in FIG. 15 (B) are reduced. Therefore, it is found that even in an amorphous sample with a degree of crystallinity of 0.0%, brittle abrasive marks can be reduced.

As shown in FIG. 9 above, in examples 1 to 6, it is possible to obtain ductile-mode plated films by setting a hardness to 7.5 to 12.7 GPa in plated films having a composition with a chromium content of 72 to 80 at %, a carbon content of 19 to 23 at %, and an oxygen content of 1.7 to 4.6 at %.

FIG. 17 is a graph showing a relationship between a deposition rate (film formation rate) and a size of oriented chromium crystal grains for the plated films of examples 2 and 5 and comparative examples 1, 4, 9, and 12.

From FIG. 17, it can be seen that the ductile-mode film has chromium grains less than 10 nm in size. It can also be seen that the size of the chromium crystal grains increases as the deposition rate becomes higher. The size of crystal grains referred to here is a value of at least one side of each grain.

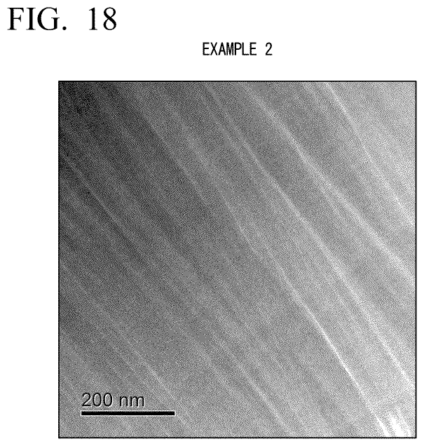

FIG. 18 shows a TEM image of a cross section of a ductile-mode film for the plated film of example 2. A presence of chromium crystal grains could not be ascertained from FIG. 18.

A structure of the plated film was observed using a scanning transmission electron microscope (STEM), and an acceleration voltage was set to 200 kV.

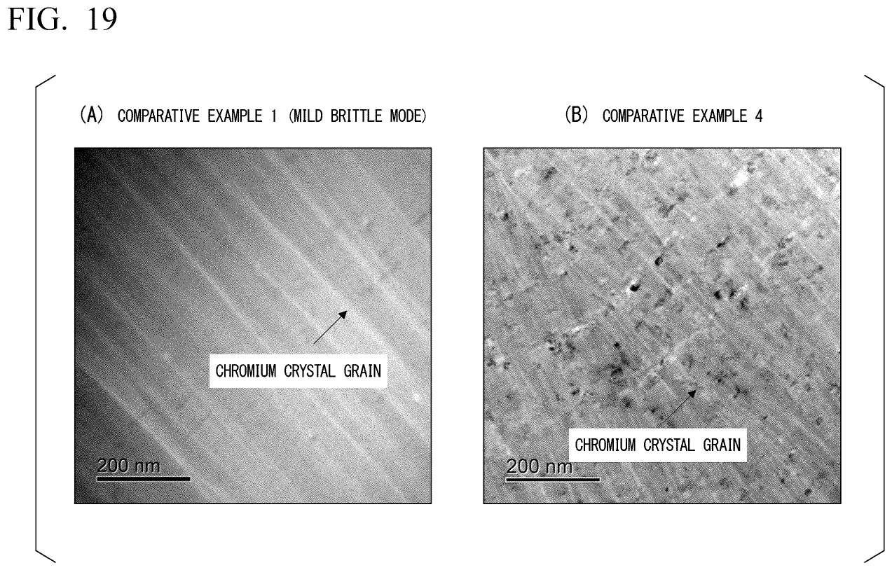

FIG. 19 shows TEM images of cross sections of the brittle-mode films for comparative example 1 and comparative example 4 in which the bath type A1 was used. In both comparative example 1 and comparative example 4, it was possible to ascertain that chromium crystal grains were present.

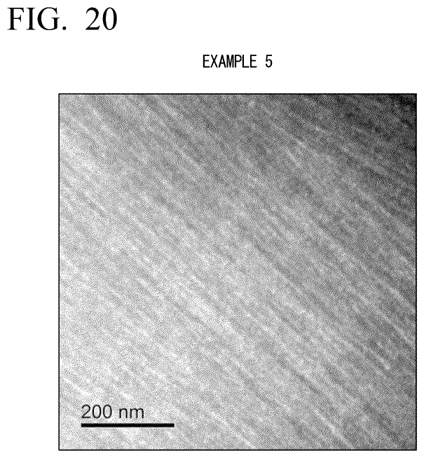

FIG. 20 shows a TEM image of a cross section of the ductile-mode film for example 5 in which the bath type A2 is used. A presence of chromium crystal grains could not be ascertained from FIG. 20.

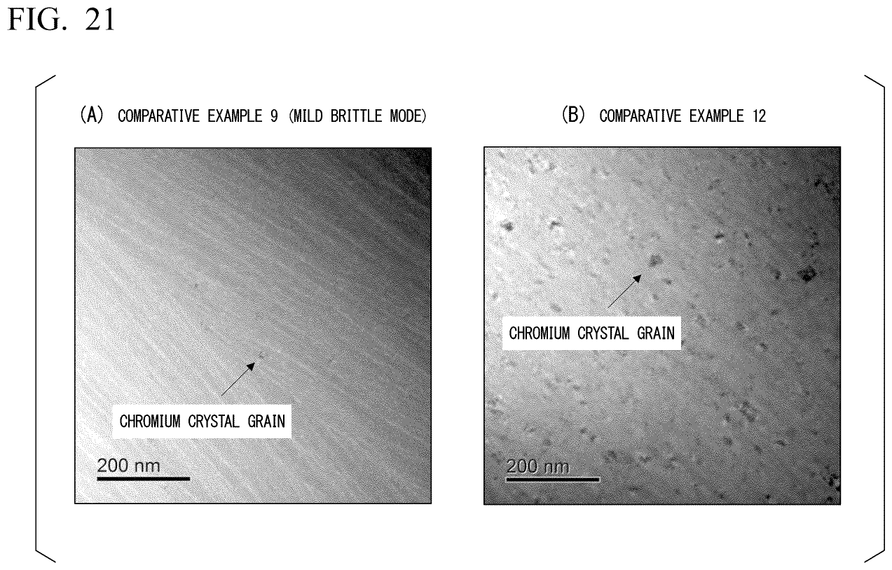

FIG. 21 shows TEM images of cross sections of brittle-mode films for comparative example 9 and comparative example 12 in which the bath type A2 was used. In both comparative example 9 and comparative example 12, it was possible to ascertain a presence of chromium crystal grains.

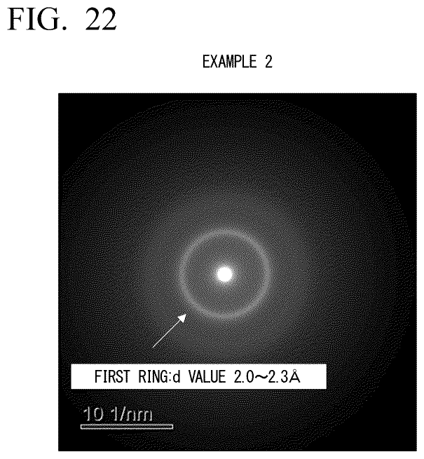

FIG. 22 shows an electron diffraction pattern in a cross section of a ductile-mode film for example 2 in which the bath type A1 was used. Measurement conditions for obtaining the electron diffraction pattern were an acceleration voltage of 200 kV, an electron beam wavelength 2 of 0.00251 nm at 200 kV, and a camera length of 399.4 mm.

From FIG. 22, it was possible to ascertain a presence of a first ring at the d value (inter-lattice plane distance) of 2.0 to 2.3 Å. This means that chromium in a form of unoriented microcrystals is present as the base material (d value of chromium: 2.04 Å). On the other hand, since diffraction spots indicating crystallinity cannot be observed on the first ring, it is considered that chromium crystal grains may not be contained.

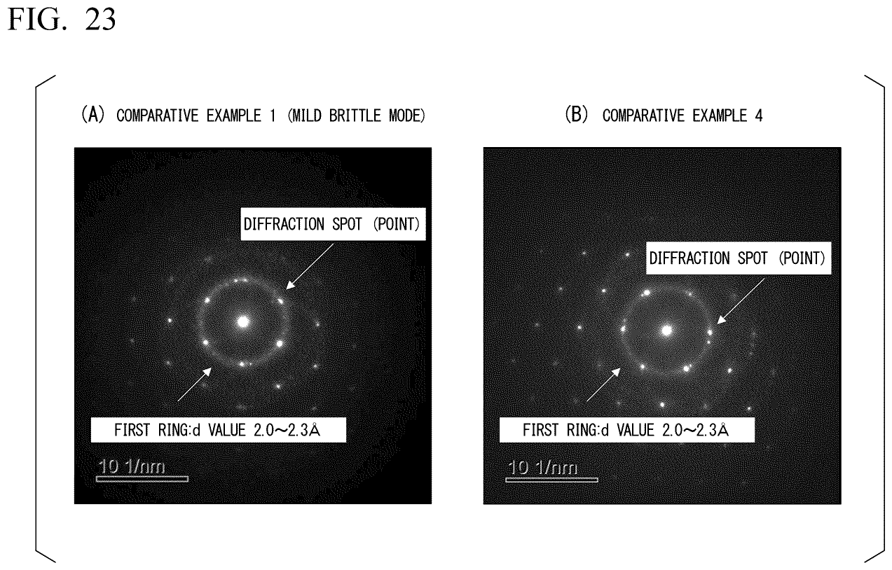

FIG. 23 shows electron diffraction patterns of cross sections of brittle-mode films for comparative example 1 (FIG. 23 (A)) and comparative example 4 (FIG. 23 (B)) in which the bath type A1 was used.

From FIG. 23, in both FIG. 23 (A) and FIG. 23 (B), it was possible to observe the first ring at a position in which the d value (inter-lattice plane distance) was 2.0 to 2.3 Å. This means that chromium in a form of unoriented microcrystals is present as the base material (d value of chromium: 2.04 Å). On the other hand, since diffraction spots indicating crystallinity can be observed on the first ring, it can be seen that oriented chromium crystal grains are present.

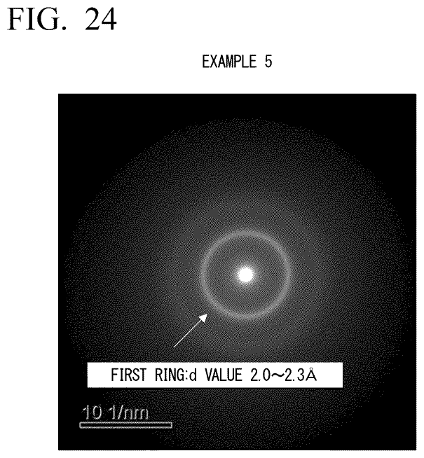

FIG. 24 shows an electron diffraction pattern in a cross section of the ductile-mode film for example 5 in which the bath type A2 was used.

From FIG. 24, it was possible to ascertain a presence of the first ring at the d value (inter-lattice plane distance) of 2.0 to 2.3 Å. This means that chromium in a form of unoriented microcrystals is present as the base material (d value of chromium: 2.04 Å). On the other hand, since diffraction spots indicating crystallinity cannot be observed on the first ring, it is considered that chromium crystal grains may not be contained.

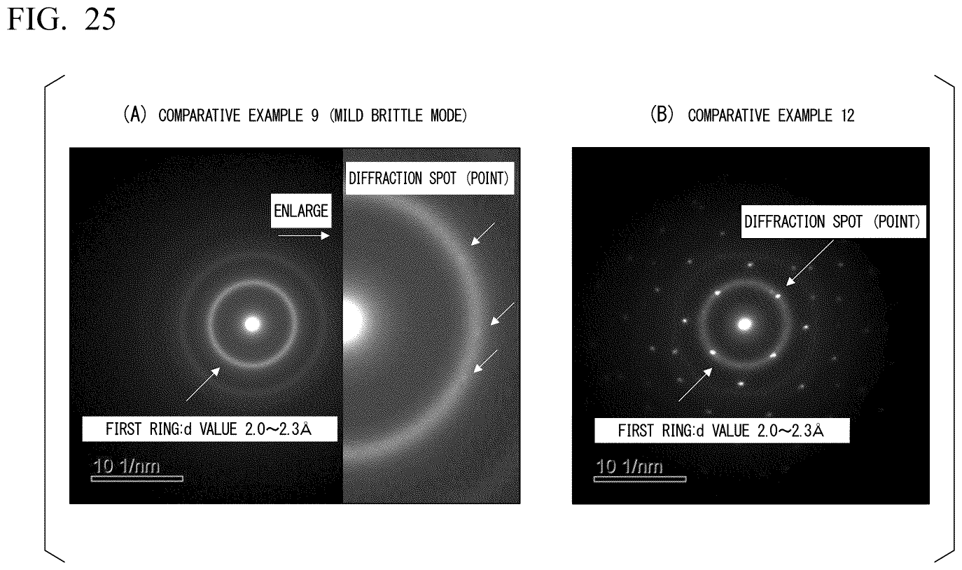

FIG. 25 shows electron diffraction patterns of cross sections of brittle-mode films for comparative example 9 (FIG. 25 (A)) and comparative example 12 (FIG. 25 (B)) in which the bath type A2 was used.

From FIG. 25, in both FIG. 25 (A) and FIG. 25 (B), it was possible to ascertain a presence of the first ring at the d value (inter-lattice plane distance) of 2.0 to 2.3 Å. This means that chromium in a form of unoriented microcrystals is present as the base material (d value of chromium: 2.04 Å). On the other hand, since diffraction spots indicating crystallinity can be observed on the first ring, it can be seen that oriented chromium crystal grains are present.

### REFERENCE SIGNS LIST

1 Shock absorber (cylinder device)
2 Inner cylinder (cylinder)
3 Outer cylinder
15 Oil seal
21 Piston rod
25 Piston
A Sliding range

1. A plated member comprising, on an outer surface, a plated film mainly composed of chromium deposited from a trivalent chromium bath containing at least chromium, carbon, and oxygen, wherein
the plated film contains 60 to 80 at % of chromium and 16.5 to 30 at % of carbon and has an indentation hardness of 7 GPa or more on the outer surface, and
a degree of crystallinity calculated from a peak integrated intensity ratio of a measured value of X-ray diffraction measurement and the following expression (1) is 4% or less,
$$Degree of crystallinity ( peak integrated intensity ratio ) = \{ \text{} ( Crystalline ) / ( Crystalline + Amorphous ) \} \times 100 \% \qquad Expression ( 1 )$$
Here, the indentation hardness indicates a value obtained by instrumented indentation hardness measurement using a nanoindentation method (ISO 14577), and the integrated intensity ratio in expression (1) indicates a value determined in an X-ray diffraction (XRD) analysis under conditions of 20:30° to 60°, a half width of crystalline: <3, and a half width of amorphous: ≥3.

2. The plated member according to claim 1, wherein the plated film does not have diffraction spots at positions corresponding to an inter-lattice plane distance d value of 2.0 to 2.2 Å in a film inspection using electron beam diffraction.

3. The plated member according to claim 1, being a sliding contact member which is in sliding contact with a sliding component.

4. The plated member according to claim 1, wherein an oxygen concentration of the plated film is 2 to 6 at %.

5. A manufacturing method of a plated member, which is a manufacturing method of a plated member having a plated film formed by plating mainly composed of chromium deposited from a trivalent chromium bath, comprising a plating process of forming a plated film formed of a hard layer mainly composed of chromium deposited from a trivalent chromium bath on a surface of the plated member, wherein
the plating process forms the plated film in a plating bath containing a trivalent chromium salt, a carboxylate, a pH buffer, and a conductivity salt at a bath temperature of 55 to 80° C. under conditions of a cathode current density of 45 to 100 A/dm², and wherein
the plated film is a plated film mainly composed of chromium deposited from a trivalent chromium bath containing at least chromium, carbon, and oxygen, and
the plated film contains 60 to 80 at % of chromium and 16.5 to 30 at % of carbon and has an indentation hardness of 7 GPa or more on an outer surface,
Here, the indentation hardness indicates a value obtained by instrumented indentation hardness measurement conducted using a nanoindentation method (ISO 14577).

6. (canceled)

7. A manufacturing method of a plated member, which is a manufacturing method of a plated member having a plated film formed by plating mainly composed of chromium deposited from a trivalent chromium bath, comprising a plating process of forming a plated film formed of a hard layer mainly composed of chromium deposited from a trivalent chromium bath on a surface of the plated member, wherein
the plating process forms the plated film in a plating bath containing a trivalent chromium salt, a carboxylate, a pH buffer, and a conductivity salt at a bath temperature of 55 to 80° C. under conditions of a cathode current density of 45 to 100 A/dm², and wherein
the plated film does not have diffraction spots at positions corresponding to an inter-lattice plane distance d value of 2.0 to 2.2 Å in a film inspection using electron beam diffraction.

8. The manufacturing method of a plated member according to claim 5, wherein the plated member is a sliding contact member which is in sliding contact with a sliding component.

9. The manufacturing method of a plated member according to claim 5, wherein an oxygen concentration of the plated film is set to 2 to 6 at %.

10. The manufacturing method of a plated member according to claim 5, wherein a degree of crystallinity in the plated member calculated from a peak integrated intensity ratio of a measured value of X-ray diffraction measurement and the following expression (1) is 4% or less,
$$Degree of crystallinity ( peak integrated intensity ratio ) = \{ \text{} ( Crystalline ) / ( Crystalline + Amorphous ) \} \times 100 \% \qquad Expression ( 1 )$$
Here, the integrated intensity ratio in expression (1) indicates a value determined in an X-ray diffraction (XRD) analysis under conditions of 2θ:30° to 60°, a half width of crystalline: <3, and a half width of amorphous: ≥3.
